(19) United States
(12) Patent Application Publication
(10) Pub. No.: US 2005/0074383 A1
(43) Pub. Date: Apr. 7, 2005

(54) Process and injection apparatus for reducing the concentration of NOX pollutants in an effluent

(76) Inventor: David Lee Wojichowski, East Hampstead, NH (US)

Correspondence Address: DAVID WOJICHOWSKI, 22 PARTRIDGE LANE, EAST HEMPSTEAD, NH, 03826, US

(21) Appl. No.: 10/674,558

(22) Filed: Oct. 1, 2003

(51) Int. Cl. B01D 53/56

(52) U.S. Cl. 423/235

(57) ABSTRACT

This invention relates to pollution control requirements for fossil fuel burning facilities, such as power plants, incinerators and cement kilns, and more particularity, to improved methods of atomizing an SNCR reagent into the combustion effluent therof.

### CROSS-REFERENCE TO RELATED APPLICATIONS

| | | |
|---|---|---|
| 3,900,554 | August 1975 | LYON |
| 4,208,386 | June 1980 | ARAND |
| 4,842,834 | June 1989 | BURTON |
| 4,915,036 | April 1990 | DEVITA |
| 5,315,941 | MAY 1994 | VETTERICK ET AL |
| 5,252,298 | October 1993 | JONES |
| 5,342,592 | August 1994 | PETER-HOBLYN ET AL |
| 5,478,542 | December 1995 | CHAWLA |
| 6,048,510 | April 2000 | ZAUDERER |

### OTHER REFERENCES

Perry's Chemical Engineer's Handbook, 5^{th} Edition.

### STATEMENT REGARDING FEDERAL SPONSORSHIP

No portion of this invention was made under government sponsored research or development.

### BACKGROUND OF THE INVENTION

The present invention relates to the reduction of pollutants, such as nitrogen oxides in an effluent, from the combustion effluent of a carbonaceous fuel. More particularly, this invention relates to a process and apparatus to accomplish this.

High temperatures, as well as hot spots of higher temperatures, cause the production of thermal NOX, the temperatures being so high that free radicals of oxygen and nitrogen are formed and chemically combined as nitrogen oxides (NOX). In addition, carbonaceous fuels contain finite quantities of nitrogen, a portion of which oxidizes to form additional nitrogen oxides.

Nitrogen oxides, especially NO, are troublesome pollutants which are found in the combustion effluent streams of large utility boilers when fired as discussed above, and comprise a major irritant in smog. It is further believed that NOX compounds can undergo a process known as photo-chemical smog formation, through a series of reactions, in the presence of sunlight and hydrocarbons. Moreover, nitrogen oxides comprise a major portion of acid rain.

Unfortunately, the high temperatures and relatively hostile environment within a utility boiler make most common methods of reducing NOX concentrations, such as effluent scrubbing or catalyst grids, uneconomical, unfeasible, or both. One economical method of reducing NOX concentrations within a combustion source is the application of Selective Non-Catalytic Reduction (SNCR), which involves the atomization of urea, ammonia, or an ammonia precursor into the combustion effluent within the temperature range of 1450 and 2000 degrees F. This harsh environment requires a specialized injection apparatus and process to maximize performance and minimize system maintenance.

There is substantial prior art relating to SNCR. The earliest of these are disclosed in expired U.S. Pat. Nos. 3,900,554 and 4,208,386. These applications describe the basic process by which ammonia and urea can be introduced to the combustion effluents for NOX reduction. Neither describes how the procedure might be done inside the combustion zone of the boiler.

The U.S. Pat. No. 4,842,834 describes an injector design which uses a coaxial supply conduit which extends into the combustion effluent. The reagent supply conduit is coaxial with, and within an outer atomization conduit until mixed within the combustion effluent cavity. Further, the supply conduit is axially slidable within the atomization conduit for droplet size adjustment. The injector design embodied in the present Application has neither coaxial conduits, nor is axially slidable. Once the injector is locked into place, the insertion length is not adjustable except by replacement of the atomization conduit.

The U.S. Pat. No. 4,915,036 describes an injector design which is a refinement to the '834 Patent, and goes further to require the utilization of an injection nozzle at the end of the atomization conduit. The use of an atomization nozzle is problematic in many highly corrosive environments, especially at the elevated temperatures required by SNCR. The present invention corrects this problem by eliminating the nozzle tip while still providing intense atomization from a plain, circular conduit.

The U.S. Pat. No. 5,315,941 describes a injector design which embodies a moving injector adjusted by a drive unit to adjust spray nozzle location based upon the measured location of the optimum temperature window. This technique of motorized adjustment of injector location is not contemplated with the present invention, which professes the advantage of fixed injectors.

The U.S. Pat. No. 5,252,298 describes an apparatus for an injection nozzle, which a large diameter body section extends through the effluent wall and has an outlet orifice. This arrangement requires large openings in the combustion effluent wall, has specially machined orifices which can wear and plug, and poorly utilizes the energy inherent in the atomization medium.

The U.S. Pat. No. 5,342,592 describes an injector assembly with an outer, coaxial, cooling jacket to protect the inner, fluid carrying, conduit. The present invention uses a single, heavy wall, high metallurgy conduit which is self-cooled by the atomization fluids.

The U.S. Pat. No. 5,478,542 describes an injector assembly which professes to operate at sonic velocity to provide atomization and fluid momentum. The present invention operates at sub-sonic conditions, and more appropriately described as critical flow. Per Perry's, the critical flow condition in flashing [two phase] flow is similar to that in single phase flow in pipes. Perry's further states that for the flow of two phase mixtures, the critical velocity may be much less than the velocity of sound in the vapor phase.

The U.S. Pat. No. 6,048,510 which sprays liquid reagents into the effluent in either a flat or conical spray pattern. The disclosure also varies the SNCR reagent and atomization medium pressures to produce different sized droplets at different locations within the combustion effluent. The present invention does neither, instead using a round, full-cone pattern and setting up constant pressures and flows to each injector.

The art is awaiting the development of a process and apparatus that would permit the use of urea or ammonia in an SNCR process in a simpler, more reliable, and more cost effective manner. This Application is intended to provide that technology.

### BRIEF SUMMARY OF THE INVENTION

The object of the current invention is to provide an improvement to the Selective Non-Catalytic Reduction system of nitrogen oxide emissions from stationary combustion sources. In particular, the invention discloses an injector apparatus which mixes an atomization medium with an SNCR reagent in a jet pump device and then conveys the mixed fluids through a single wall atomization conduit into the combustion effluent, where it is atomized into the effluent to effect the SNCR Reaction. The injector apparatus improves the performance and simplifies the entire SNCR process, resulting in an acute technological advantage.

### BRIEF DESCRIPTION OF THE DRAWINGS

FIG. 1 Injector Apparatus This Drawing depicts the injector assembly. The atomization fluid is introduced axially into the injector assembly, which then mixes with the SNCR reagent in the eductor body. The two phase fluid is transported down the atomization conduit where it enters the combustion effluent.

FIG. 2 Process Flow Diagram This drawing shows a simplified mechanical arrangement of the SNCR process. An atomization fluid is introduced to the injector assembly along with the SNCR reagent. The two-phase fluid is atomized and dispersed into the boiler to enable efficient SNCR reactions.

FIG. 3 Injector Apparatus This Drawing depicts an alternate injector assembly. The atomization fluid is introduced axially into the injector assembly, which then mixes with the SNCR reagent in a mixing tee. The two phase fluid is transported down the atomization conduit where it enters the combustion effluent.

### DETAILED DESCRIPTION OF THE INVENTION

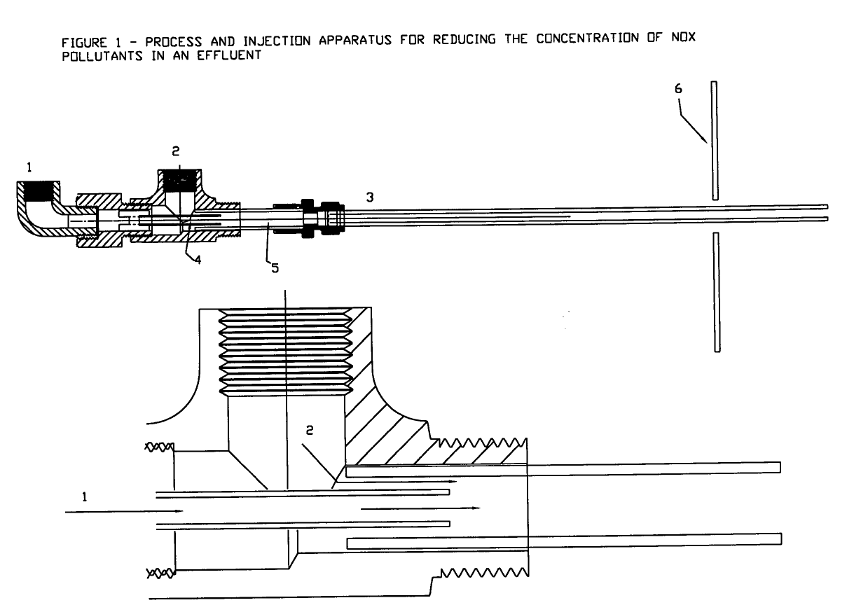

FIG. 1 illustrates one version of the injector apparatus in which an atomization medium is introduced to the assembly in the axial direction, item 1. The atomization medium travels through a small inner conduit, terminating coaxially and concentrically inside a larger mixing chamber, item 5. The SNCR reagent, either liquid or gaseous is introduced to the mixing chamber via the annular opening formed between the atomization medium conduit and the mixing chamber. The orientation of the two fluid streams allows the transfer of energy and momentum from the atomization medium to the SNCR reagent. The mixed fluids are conveyed past the boiler wall (item 6) via a single walled atomization conduit (item 3). The atomization conduit extends into the combustion effluent and produces a jet spray which mixes the SNCR reagent with the combustion effluent.

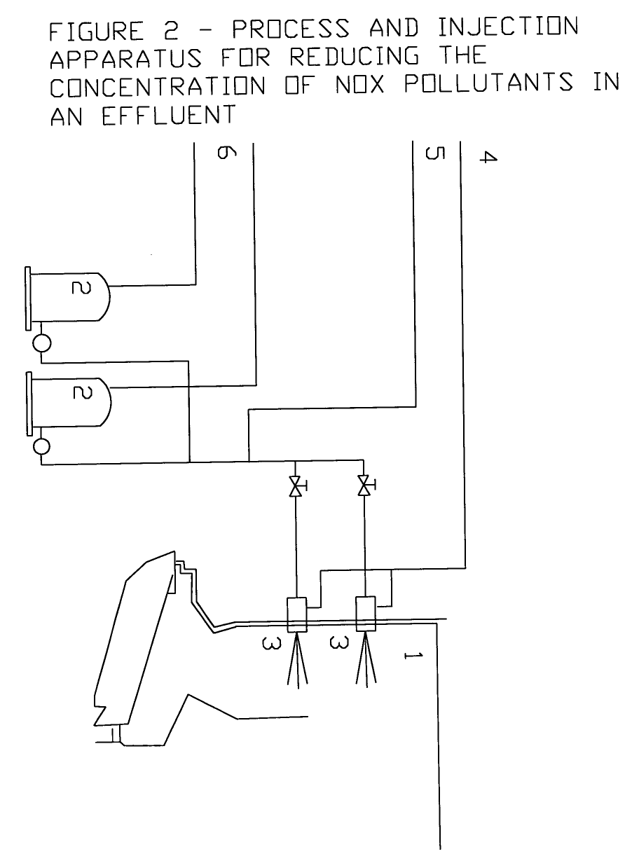

FIG. 2 is a schematic diagram of the overall SNCR process. The combustor, item 1, produces a high temperature effluent into which SNCR injectors, items 3, atomizes the SNCR reagent. The reagent is stored in tankage, item 2, and introduced to a distribution header at a flow controlled to maintain the pre-selected NOX concentration. Additional dilution water, item 5, may or may not be blended with the reagent depending upon the specific application. Atomization medium (item 4), either compressed air or steam, is introduced directly to the injector assemblies.

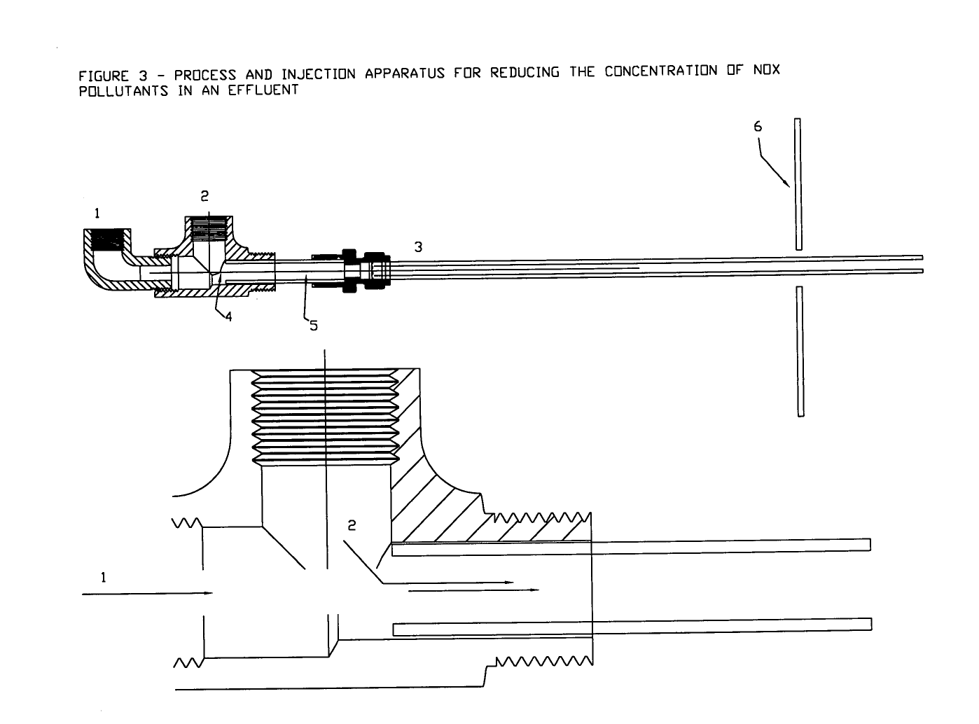

FIG. 3 illustrates another version of the injector apparatus in which an atomization medium is introduced to the assembly in the axial direction, item 1. The SNCR reagent, either liquid or gaseous is introduced to the mixing tee along with the atomization medium. The mixed fluids are introduced to the atomization conduit (item 3) and conveyed past the boiler wall (item 6). The atomization conduit extends into the combustion effluent and produces a jet spray which mixes the SNCR reagent with the combustion effluent.

### DESCRIPTION OF THE IMPROVEMENTS

The Injection Apparatus improves the basic Process in several key ways. Overall, the apparatus is simpler and therefore less expensive than current commercially proven alternatives.

As described in Perry's, a jet pump is a liquid handling device that makes use of the momentum from one fluid to move another, in this case from an atomizing medium to a liquid SNCR reagent. There are two general types of jet pumps, injectors and ejectors. The net effect of either is more efficient utilization of the Pressure-Volume energy in the atomizing medium, thereby lowering the fluid pressure requirement of the SNCR reagent. In many cases, this eliminates the requirement of separate booster pumps for the SNCR reagent and/or dilution water systems—a significant simplification and cost reduction factor.

In a demonstration at a 430,000 pph biomass boiler, the SNCR system used compressed air for atomization, which operates at a system pressure of 90-110 psig. The pressure of the atomization medium was reduced prior to the injection nozzle to 50-60 psig. Substituting the jet pump injector allowed the application of higher atomization medium pressure to the injector, approximately 90 psig, and demonstrated superior SNCR chemical efficiency. The net effect was lower energy consumption by better utilization of the energy in the atomization medium, and better chemical utilization by reducing the required quantity of SNCR reagent.

A second improvement is realized by the minimization of internal clogging in the mixing chamber. A typical injector has small orifices for passage of atomization medium and SNCR reagents, which can get clogged from chemical scaling and impurities. The present invention has larger flow passages which is less likely to clog. As such, the present invention also allows the use of a poorer quality water, and in some cases industrial wastewater to be processed, and effectively disposed, in the SNCR process.

A third set of improvements is realized by virtue of the single atomization conduit. Flow of atomization medium and reagent cools the portion of the conduit exposed to effluent temperatures. The outer tube of a typical tube-within-a-tube concentric design does not see the cooling effect of the atomizing medium and SNCR reagent. The higher metal temperatures resultant from lower cooling will fatigue the metal, resulting in significantly lower service life. This fact has been proven on highly acidic refuse incineration unit SNCR systems. Further, the premium cooling effect allows the extension of the atomization conduit inside the effluent to a greater extent, minimizing the occurrence of localized wall wetting and resultant boiler tube metal loss and failure. Lastly, the smaller profile of the single atomizing conduit approach allows the installation of the injector through smaller ports—as small as 7/16″ diameter. This often eliminates the need to modify boiler tube pressure parts to accommodate the injectors—a significant advantage in terms of cost and convenience.

1. A process for reducing the concentration of nitrogen oxides in an effluent gas stream from combustion of a carbon containing fuel in a boiler or furnace, comprising:
a. Providing one or more single-walled, fixed-position, atomization conduits which carries both SNCR reagent (either liquid urea, vaporous ammonia, aqua ammonia, or a liquid ammonia precursor) and an atomization medium (either steam or compressed air), and which extends through the wall of the effluent chamber into the effluent gas.
b. Mixing the atomizing medium with the SNCR reagent outside of the combustion effluent chamber in a jet pump apparatus such as an injector or ejector.
c. Said mixing chamber discharging directly to said atomization conduit.
d. The discharge end of the atomization conduit having an exit geometry neither changed in size nor shape from the atomization conduit.

2. A process according to claim 1, wherein the metallurgy of the atomization conduit is constructed of a nickel/chromium alloy such as Inconel, Hastelloy, or Stellite.

3. A process according to claim 1, wherein the atomization conduit is extended into the effluent gas a distance of 5 inches or greater, to provide greater penetration of the SNCR reagent into the effluent gas.

4. A process according to claim 1, wherein the atomization conduit is extended into the effluent gas a distance of 5 inches or greater, to provide reduce droplet impingement on the inside of the effluent chamber for corrosion minimization.

5. A process according to claim 1, wherein the pressure of the SNCR reagent at the point of entry into the mixing chamber is at least 10 psig less than the pressure of the SNCR reagent entering the mixing chamber.

6. A process for reducing the concentration of nitrogen oxides in an effluent gas stream from combustion of a carbon containing fuel in a boiler or furnace, comprising:
a. Providing one or more single-walled, fixed-position, atomization conduits which carries both SNCR reagent (either liquid urea, vaporous ammonia, aqua ammonia, or a liquid ammonia precursor) and an atomization medium (either steam or compressed air), and which extends through the wall of the effluent chamber into the effluent gas.
b. Mixing the atomizing medium with the SNCR reagent outside of the combustion effluent chamber in a mixing tee.
c. Said mixing chamber discharging directly to said atomization conduit.
d. The discharge end of the atomization conduit having an exit geometry neither changed in size nor shape from the atomization conduit.

7. A process according to claim 6, wherein the metallurgy of the atomization conduit is constructed of a nickel/chromium alloy such as Inconel, Hastelloy, or Stellite.

8. A process according to claim 6, wherein the atomization conduit is extended into the effluent gas a distance of 5 inches or greater, to provide greater penetration of the SNCR reagent into the effluent gas.

9. A process according to claim 6, wherein the atomization conduit is extended into the effluent gas a distance of 5 inches or greater, to provide reduce droplet impingement on the inside of the effluent chamber for corrosion minimization.

10. A process according to claim 6, wherein the pressure of the SNCR reagent at the point of entry into the mixing chamber is at least 10 psig less than the pressure of the SNCR reagent entering the mixing chamber.

11. A process for conditioning an effluent gas stream from combustion of a carbon containing fuel in a boiler or furnace, comprising:
a. Providing one or more single-walled, fixed-position, atomization conduits which carries both water and an atomization medium (either steam or compressed air), and which extends through the wall of the effluent chamber into the effluent gas.
b. Mixing the atomizing medium with water outside of the combustion effluent chamber in a jet pump apparatus such as an eductor or ejector.
c. Said mixing chamber discharging directly to said atomization conduit.
d. The discharge end of the atomization conduit having an exit geometry neither changed in size nor shape from the atomization conduit.

12. A process according to claim 11, wherein the metallurgy of the atomization conduit is constructed of a nickel/chromium alloy such as Inconel, Hastelloy, or Stellite.

13. A process according to claim 11, wherein the atomization conduit is extended into the effluent gas a distance of 5 inches or greater, to provide greater penetration of the water into the effluent gas.

14. A process according to claim 11, wherein the atomization conduit is extended into the effluent gas a distance of 5 inches or greater, to provide reduce droplet impingement on the inside of the effluent chamber for corrosion minimization.
